(19) United States
(12) Patent Application Publication
(10) Pub. No.: US 2026/0036105 A1
(43) Pub. Date: Feb. 5, 2026

(54) HYDROGEN AND OXYGEN INJECTION IN AN ACTIVE PRE-CHAMBER IGNITION ENGINE

(71) Applicant: Purdue Research Foundation, West Lafayette, IN (US)

(72) Inventors: Li Qiao, West Lafayette, IN (US); Dong Eun Lee, Fremont, CA (US); Tianxiao Yu, Westmont, IL (US)

(73) Assignee: Purdue Research Foundation, West Lafayette, IN (US)

(21) Appl. No.: 19/287,545

(22) Filed: Jul. 31, 2025

Related U.S. Application Data
(60) Provisional application No. 63/678,810, filed on Aug. 2, 2024.

(51) Int. Cl. F02M 21/02; F02B 19/10; F02B 19/12

(52) U.S. Cl. CPC F02M 21/0287; F02B 19/1023; F02B 19/108; F02B 19/12; F02M 21/0206

(57) ABSTRACT

A pre-chamber combustion system is disclosed for use with an internal combustion engine. The system includes a pre-chamber fluidly connected to a main combustion chamber through at least one pre-chamber nozzle. An electrolyzer is configured to receive liquid water and generate gaseous hydrogen and gaseous oxygen. The generated gases are directed into the pre-chamber, where they are ignited to initiate combustion. The resulting high-temperature combustion produces hot gas jets that are discharged into the main chamber to enhance ignition and combustion efficiency. The system enables on-demand production and combustion of hydrogen and oxygen without requiring external fuel sources, potentially improving engine performance and reducing emissions.

### CROSS REFERENCE TO RELATED APPLICATIONS

This application claims the benefit of U.S. Provisional Application No. 63/678,810 filed Aug. 2, 2024, the entirety of which is hereby incorporated by reference.

### TECHNICAL FIELD

This disclosure relates to reciprocating engine and, in particular, to pre-chamber combustion for reciprocating engines.

### BACKGROUND

As the global population continues to grow, the demand for energy to power homes, businesses, industry, and transportation increases annually. In the industry and transportation sectors, spark ignition (SI) engines have been widely utilized, however, burning fossil fuel produces greenhouse gases such as CO2, which accelerates global warming. Additionally, toxic gases such as nitrogen oxides (NOx) are emitted, which can have a detrimental effect on the health of humans and animals. These facts motivate engine research to focus on fuel economy, engine efficiency, and reduction of NOx emissions in order to meet energy demands and mitigate the negative impacts of SI engines.

To simultaneously achieve the three targets mentioned above, the exhaust gas recirculation (EGR) technique has been developed. By recirculating the exhaust gas from the previous cycle to mix with fresh intake gas in the intake port of the succeeding cycle, the throttle can be opened further to reduce the pumping loss at part load conditions. Burning the exhaust gas a second time allows for the remaining hydrocarbon (HC) in the exhaust gas to be consumed, resulting in increased fuel economy and engine efficiency, as well as fewer greenhouse gas emissions. Additionally, the exhaust gas decreases the peak gas temperature during combustion, leading to a reduction in NOx generation as the activation energy for nitrogen oxidation is less exceeded. However, the EGR technique entails some challenges. An increased EGR ratio decreases the gas temperature during combustion and the local reaction rate, resulting in a decreased flame propagation speed. This may lead to incomplete combustion, high cycle-to-cycle variations, and even misfires.

These challenges can be overcome by using pre-chamber jet ignition (PJI). In the PJI, a hollow metal cylinder is installed on the spark plug of a standard SI engine, forming a small volume, pre-chamber, filled with a gas mixture around the spark plug. The pre-chamber (PC) and the main chamber (MC) are connected by several nozzles at the bottom of the PC. When the PC gas is ignited, the pressure difference between the PC and MC drives hot reactive PC gas into the MC, generating high-temperature and highly turbulent jets to ignite the MC gas mixture. This creates a large number of ignition sites on the jet surface, resulting in a fast burn rate and stable combustion even at high dilution conditions. There are two approaches to apply the PJI: the passive PJI and the active PJI. The passive PJI has a simple design and low cost, but its jet quality is relatively weak at high EGR ratios. The active PJI has a separate injector to control the PC gas composition, allowing for an extension of the EGR limit of the MC even at high EGR ratios. However, this approach has disadvantages of a complex engine design, increased cost, as well as difficult atomizing of liquid fuel in a small volume such as fuel impingement on the inner pre-chamber walls. The third challenge can be solved by using gaseous hydrogen as the PC fuel, which will be explained in the following paragraph.

To overcome the challenges of liquid fuel injection in PC, gaseous hydrogen is being considered as a potential PC fuel. The use of hydrogen in an active pre-chamber offers numerous advantages over other fuels, especially liquid fuels like gasoline. First, hydrogen has the highest heating value of all competitors, three times that of gasoline. Additionally, its high reactivity and diffusivity result in a fast laminar flame speed and burn rate. Furthermore, hydrogen has a wide flammability limit and low ignition energy, making it desirable for igniting gas mixture with a high EGR ratio. Moreover, the oxidation of hydrogen generates non-carbo-based products, reducing greenhouse gas emissions.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a first example of a pre-chamber injection system.

FIG. 2 illustrates an of a flow chart with accompanying graphics for the pre-chamber injection system.

### DETAILED DESCRIPTION

A drawback of using gaseous hydrogen as pre-chamber combustion fuel is the issue of hydrogen storage due to its low volumetric energy density and potential for leakage. To address this and other issues of hydrogen storage, this disclosure introduces using gaseous hydrogen generated by onboard water electrolysis. This involves a small electrolyzer converting liquid water from an onboard water tank into gaseous hydrogen and oxygen, eliminating the need for a separate onboard hydrogen storage system and addressing the potential drawbacks.

Numerous studies have been conducted to better understand the effects of active PJI on high-dilution conditions. For example, Liu, Y., Jia, M., Xie, M., and Pang, B., Energy & Fuels, 26 (12): 7069-7083, 2012 compared active pre-chamber ignition systems between using methane and using hydrogen as PC fuel. They found out that using hydrogen generated faster jets and achieved higher engine efficiency, though it exhibited a stronger tendency for auto-ignition. Santos et al. discovered that the cycle-to-cycle variation decreases because of the turbulence-enhanced jet ignition. Further, Zhou, L., Liu, P., Zhong, L., Feng, Z., and Wei, H., Fuel, vol. 305, 2021 observed shock waves and pressure oscillations in the cylinder because of strong jets formed by hydrogen combustion in PC. Additionally, Zhong, L., Liu, P., Zhou, L., and Wei, H., Proceedings of the Combustion Institute, 2022 explored an active PJI system fueled with hydrogen and oxygen to extend the EGR limit in a constant volume chamber. They observed four ignition phenomena, including jet re-ignition, flame buoyancy, re-ignition failure, and complete misfire with increased EGR ratio, with the EGR limit observed to be 65%.

The system and methods described herein provide active PC injection with hydrogen on PC combustion, jet formation, and MC turbulent jet ignition, all under a high EGR ratio and onboard electrolysis. To achieve this, local mass fractions were used to study the composition distributions. Energy ratios were used to evaluate the mixture heating values of the PC and the MC. Velocities, turbulent kinetic energies (TKE), and OH mass fractions were employed to investigate the jet characteristics, and iso-temperature surfaces combined with Damköhler and Karlovitz numbers were utilized to analyze the flame propagation affected by the turbulence chemistry interaction.

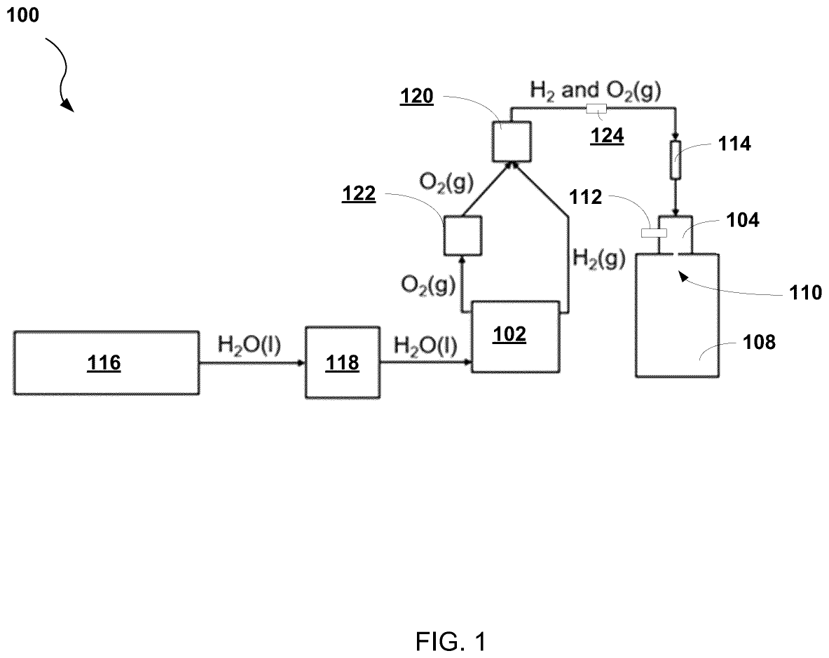

FIG. 1 illustrates a first example of a pre-chamber injection system 100. The system 100 may include an electrolyzer 102 and a pre-chamber 104. The pre-chamber 104 may fluidly connect to a main chamber 108 (engine cylinder) through at least one small pre-chamber nozzle 110, though multiple nozzles from the pre-chamber are preferred. The electrolyzer 102 may receive water and separate the water into gaseous hydrogen and oxygen. The pre-chamber 104 may receive the gaseous hydrogen and oxygen to perform pre-combustion. For example, a spark plug 112 may be at least partially disposed within the pre-chamber to introduce spark to the gaseous hydrogen and oxygen. In some examples, the system 100 may include a gas injector 114 to inject the gaseous hydrogen and oxygen into the pre-chamber 104.

The system 100 may further include a water tank 116 and a pump 118. The pump 118 may pump water from the tank 116 to the electrolyzer 102 and increases the pressure to about 30 bar, or some other suitable pressure, depending on the engine. The system 110 may include a reservoir 120 which stores the gaseous hydrogen and oxygen before being injected into the pre-chamber. The system 100 may include a check valve 122 which may regulate the oxygen flow into the gas reservoir 120.

During operation, liquid water from the water tank 116 is pressurized by the high-pressure water pump 118. The pressurized water is then converted into gaseous hydrogen and oxygen through electrolysis by the electrolyzer 102. To achieve a desired equivalence ratio, the oxygen flow rate is regulated by the check valve 122 before being mixed with the hydrogen flow in the gas reservoir. The resulting hydrogen and oxygen mixture is injected into the pre-chamber by an injector to enhance the quality of jets in the engine cylinder. Two equivalence ratios, stoichiometry and rich, were tested to study the effect of jet temperature and jet velocity on flame propagation.

In some examples, the system may include a sensor 124 which measures a mass ratio of oxygen to hydrogen at a particular location in the system. By way of example, the sensor 124 may include a lambda sensor. A controller may receive the measurement readings from the sensor 124 and control the valve 122 to regulate the ratio of oxygen to hydrogen in the reservoir and upstream therefrom. It should be appreciated that the controller may utilize additional and alternative measurements from other sensors in the system. The controller may cause the valve 120 to be adjusted in order to achieve a desired outcome regarding the amount of gaseous hydrogen and oxygen flowing to the pre-chamber 104. For example, the controller may access predefined rules that regulate the valve in response to measurements from the sensor 124, or other sensors in the system.

A technical advantage of the system described herein is the utilization of an electrolyzer to convert liquid water from an onboard tank into gaseous hydrogen and oxygen. These gases are then used to fill a pre-chamber 104, resulting in improved jet quality. The pre-chamber, with a volume of only 1 cc for example, requires a low mass flow rate of hydrogen, which can easily be produced by the electrolyzer with minimal volume, mass, and energy requirements. These features make the present concept feasible for use in passage vehicles. The application of this method for producing gaseous hydrogen and oxygen eliminates the need for a hydrogen chamber, which presents numerous challenges associated with hydrogen storage. First, the potential for leakage when storing gaseous hydrogen in a reservoir due to its small molecule size. Additionally, storing liquid hydrogen in a tank requires a significant amount of energy, as it must be kept at an extremely low temperature of −253° C.

The pre-chamber injection system may be utilized in gas combustion systems. For example, a vehicle may include the injection system. In some cases, the system may include multiple components, such as the gas injector and pre-chamber, for each cylinder of a gas engine. Alternatively or in addition, the system may include multiple gas reservoirs, electrolyzer, and/or check valves, depending on the size and number of chambers present in the engine. In some examples, the pre-chamber may be designed to plug directly into the spark plug holes of the gas engine, using well known form factors. In any design, however, the main-chamber(s) engine receive combustion through hot jets from the pre-chamber(s) using gaseous hydrogen and oxygen according to the various embodiments described herein.

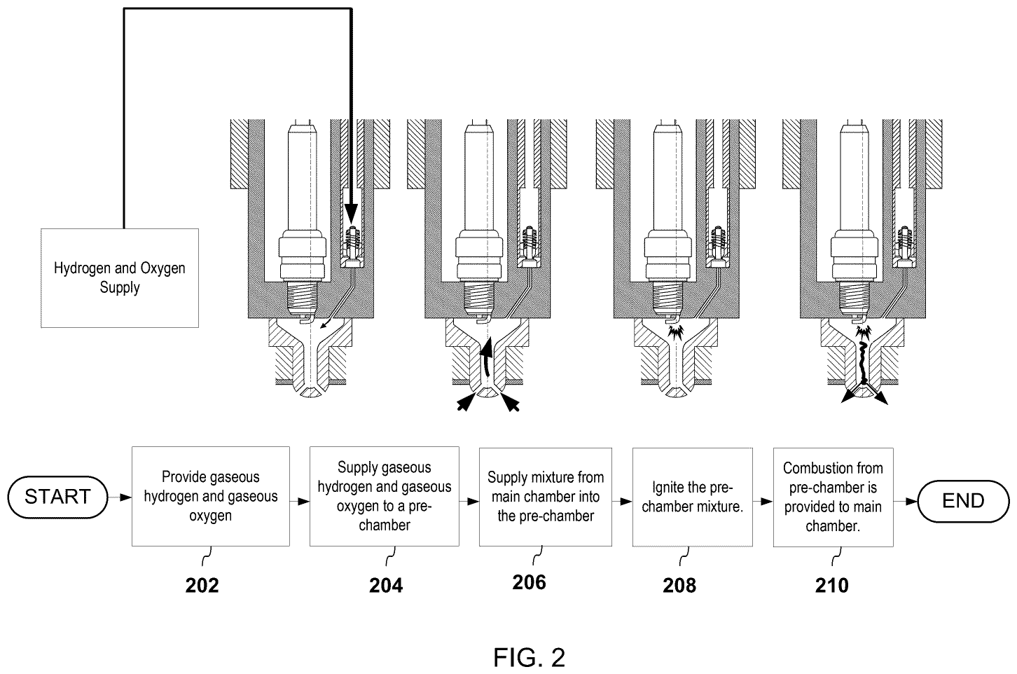

FIG. 2 illustrates an of a flow chart with accompanying graphics for the pre-chamber injection system. A hydrogen and oxygen supply may provide a mixture including gaseous hydrogen and gaseous oxygen (202). For example, the hydrogen and oxygen supply may include the electrolyzer 102, water tank 116, pump 118, gas reservoir 120, check valve 122, and/or any other components involved in the hydrogen and oxygen production described herein. The hydrogen and oxygen supply may, for example, convert water into gaseous hydrogen and gaseous oxygen, and or regulate the amount of gaseous hydrogen and gaseous oxygen in a mixture provided by the hydrogen and oxygen supply.

The hydrogen and oxygen supply may supply gaseous hydrogen and gaseous oxygen to a pre-chamber (204). The pre-chamber may include a nozzle. The main chamber may provide a fuel mixture, which is compressed with air into the pre-chamber (206) by the piston during the compression stroke. The fuel mixture from the main chamber may combine with the gaseous hydrogen and gaseous oxygen mixture present in the pre-chamber.

The spark plug may ignite the mixture (208). The resultant combustion from the pre-chamber is provided to the main chamber (210). The combustion in the pre-chamber may provide hot jets which are expelled via the pre-chamber nozzle(s) into the main chamber.

Various experimentation and validation were conducted using the system and methods described herein. The experimentation, among other aspects described herein, explored using a hydrogen-oxygen gas mixture generated by an electrolyzer and injected in a PC to improve jet qualities for a jet ignition engine. As hydrogen is only used to fuel the PC, the hydrogen mass flow is relatively low, which can be generated by a small electrolyzer, such as the examples shown in Table 1, under a total volume of 10 cubic centimeters, along with an onboard water tank. Table 3 shows that the electrolyzer Quattro, which has a larger size, a higher weight, and a higher operating power, generates more than 6 times volumetric flow of hydrogen compared to Horizon PEM Blue. The application of electrolyzers to convert liquid water into a hydrogen-oxygen gas mixture addresses the challenge of hydrogen storage in vehicles. This concept makes active PC injection with hydrogen more feasible.

TABLE 1
Electrolyzer Specifications

| | | | | Operating | Hydrogen |
|---|---|---|---|---|---|
| | Dimensions | Weight | | Current [A] × | production rate |
| Electrolyzer | [mm3] | [g] | | Voltage [V] | [mL/min] |
| Quattro [25] | 75 × 71 × 53 | 82.21 | g | 1.65 A × 8.0 V | 46 |
| Horizon | 54 × 54 × 17 | 69.7 | g | 1 A × 3 V | 7 |
| PEM Blue | | | | | |

To investigate the effect of the active PC injection with hydrogen on the jet ignition engine, two PC injection strategies (S1 and S2) were designed and listed in Table 4. Both strategies had an injection pressure of 30 bar. S1 injected a stoichiometric H₂—O₂ gas mixture into the PC, and S2 injected a richer mixture with a λ of 0.56. The injection duration for S1 was adjusted to 2.5 oCA, which was shorter than the 2.75 oCA used for S2. This was done to compensate for the higher molecular weight of S1 and to ensure that both strategies had an equal amount of injected mass of 1.24 mg per cycle. Furthermore, the spark timings were selected to make the jet formation occur at the same time for both the strategies: 704 oCA for S1 and 705 oCA for S2. The start of the PC injection was set to be 10 oCA before the spark timings to give the injected gas enough time to mix with the original PC mixture of gasoline, air, and exhaust gas. Finally, both strategies were tested under the same engine condition with an MC EGR ratio of 30% and a PC nozzle diameter of 1.5 mm.

TABLE 2
Pre-chamber injection strategies

| | PC | Composition | PC | | | Hydrogen |
|---|---|---|---|---|---|---|
| | injection | of PC | injection | Spark | | production |
| Strategy | pressure | injection | duration | timing | SOI | rate |
| number | (bar) | (λ) | (deg) | (deg) | (deg) | (mL/min) |
| 1 | 30 | H₂—O₂ (1) | 2.5 | 704 | 694 | 25 |
| 2 | 30 | H₂—O₂ (0.56) | 2.75 | 705 | 695 | 30 |

Numerical engine models were generated to simulate a modified GM LTG four-cylinder turbocharged pre-chamber engine. This engine was fueled with gasoline directly injected (GDI) into the cylinder and had a high compression ratio of 14. A 6-straight-nozzle pre-chamber with a nozzle diameter of D=1.5 mm was installed in the middle of the cylinder head through the spark plug housing, with an inclined angle of 4° to the cylinder axis. The engine specifications and pre-chamber parameters are listed in Tables 3 and 4, respectively.

TABLE 3
Engine Specifications

| | |
|---|---|
| Compression Ratio | 14 |
| Bore × Stroke | 86 × 94.6 mm |
| Fuel Delivery | Side-mounted GDI |
| Fuel SOI | 420oCA |
| Fuel Rail Pressure (bar) | 65 |
| Main chamber (MC) lambda | 1.0 |

TABLE 4
Pre-chamber Parameters

| | | Nozzle Diameter | Tot. Area | A/V |
|---|---|---|---|---|
| | Nozzle # | [mm] | [mm2] | (1/m) |
| PC | 6 | 1.5 | 10.6 | 8.76 |

Conventions-Turbulent jet ignition involves the development of the turbulence-chemistry interaction, which can be illustrated in the classical premixed flame Borghi-Peters diagram. In PC engines, the turbulent transient jets form and dissipate because of the PC-MC pressure difference, while the hot jets ignite MC mixture to generate a flame that propagates in the cylinder. As a result, the turbulent and chemical features interact, causing the combustion to pass through various zones in the Borghi-diagram. To determine the regime(s) in which the jet ignition fall into, four variables describing the jet properties at various timings after top dead center (ATDC) were calculated: the laminar flame thickness (l_{f}), laminar flame speed (s_{L}), the turbulent length scale (lₜ), and the turbulent velocity (u′).

Damköhler (Da) is a dimensionless number used to explain the delayed jet ignition and the local extinction of jet ignition. It is defined as the ratio of the characteristic (turbulent) mixing time scale, Tₘ, to the characteristic chemical reaction time scale, T_{c}. Da can be expressed as

$$Da = \frac{{τ}_{m}}{{τ}_{c}} = \frac{{l}_{t} {s}_{L}}{{l}_{f} {u}^{′}} \qquad Eq . 1$$

In this form, Da represents a ratio of the chemical reaction rate to the mixing rate. When Da number value is very low, the turbulent intensity is too strong and the mixing rate is too large, resulting in the diffusive heat loss rate exceeding the combustion heat release rate, which can lead to local extinction.

Karlovitz number (Ka) is a dimensionless number, which is used to describe the turbulence chemistry interaction, is define as the ratio of the characteristic chemical reaction time scale Tcto the Kolmogorov time scale τₘ. The Kolmogorov scales, which include the time scale τ_{η}, the length scale η, and the velocity scale uη, are the most minuscule scales in turbulent flow. Let l_{δ} represent the thickness of the reaction zone which is calculated as l_{δ}=0.1 l_{f}. Ka can be changed into:

$$Ka = \frac{{τ}_{c}}{{τ}_{η}} = \frac{{l}_{f}^{2}}{{η}^{2}} = 100 \frac{{l}_{δ}^{2}}{{η}^{2}} \qquad Eq . 2$$

Thus, Ka evaluates the ratio of l_{δ} to η directly. At Ka numbers slightly below 100, the eddies are of the ideal size to accelerate the flame. At this Ka number, the length scale η of the smallest eddies is larger than the thickness of the reaction zone l_{δ}, meaning that the smallest eddies avoid penetrating and disturbing the reaction zone. On the other hand, η is much smaller than the laminar flame thickness l_{f}, which allows all turbulent eddies stretching the preheat zone of the flame, maximizing the flame surface area and heat transfer from the hot burned gas to the cold unburned gas. This results in a strong acceleration of the local combustion and a maximum heat release rate. Additionally, Ka being greater than 100 does not necessarily mean local extinction, since distributed combustion with Ka=2000 was observed in Aspden's work [26].

Results—The engine was operated at a main chamber (MC) λ of 1, a MC EGR ratio of 30%, and an engine speed of 1500 RPM. The two PC injection strategies, namely stoichiometric and rich injection for S1 and S2, were analyzed in terms of PC injection, jet formation, and MC combustion. To gain insight into the turbulence-chemistry interaction of the turbulent jet ignition process in the MC, Borghi-Peters diagrams, local Damköhler numbers, and local Karlovitz numbers were utilized.

The evaluation of the two active PC injection strategies focused on the injected hydrogen mass, the PC mixture air-to-fuel equivalence ratio λ, and the jet formation. When comparing PC injection strategy S1 with a stoichiometric PC mixture to PC injection strategy S2 with a rich PC mixture at the spark timing, it was found that S1 generated a lower PC-MC pressure difference, slower but hotter jets, and a higher peak MC pressure than S2. This indicates that the jet temperature is the primary factor in generating faster combustion and higher pressure in the MC mixture with a high-dilution ratio. As a result, S1 is the preferred option for achieving optimal engine performance and efficiency under high EGR conditions because of its higher jet temperature and faster MC combustion.

The delayed jet ignition is correlated to the local Da number. During the early stage of the jet formation, a low Da number value was observed across the whole jet surface for the three strategies. This is because of the high EGR ratio of the MC mixture, which leads to a low s_{L}, thus resulting in a low Da from the chemical perspective. From the gas dynamic perspective, high-TKE jets caused by the hydrogen combustion in the PC result in a high u′, further decreasing the Da number value. The low Da number value indicates a temporarily faster diffusive heat loss rate than the combustion heat release rate, resulting in a delayed jet ignition, which was observed as a very low global heat release rate during this period in the MC.

The local heat release rate on the jet surface is linked to the local Ka number. A peak heat release rate is observed at the jet lateral side for the three strategies when the local Ka number value reaches 100. This is because the turbulent eddies have the optimal size to maximize the flame surface area and the heat transfer from the hot burned gas to the cold unburned gas, accelerating the local heat release rate. Additionally, S1 reaches this critical Ka number value earlier than S2 because of the higher jet temperature in S1, which indicates an earlier acceleration of the flame propagation, resulting in a larger flame surface at the lateral side in comparison to S2.

While various embodiments have been described, it will be apparent to those of ordinary skill in the art that many more embodiments and implementations are possible. Accordingly, the embodiments described herein are examples, not the only possible embodiments and implementations.

What is claimed is:

1. A pre-chamber combustion system comprising:
a pre-chamber fluidly connected to a main chamber of an engine through a pre-chamber nozzle;
an electrolyzer configured to receive liquid water and output gaseous oxygen and gaseous hydrogen,
wherein the gaseous oxygen and the gaseous hydrogen output from the electrolyzer is ignited in the pre-chamber to produce hot jets into the main chamber.

2. The pre-chamber combustion system of claim 1, further comprising
a gas reservoir configured to store the gaseous hydrogen and the gaseous oxygen output from the electrolyzer, wherein the pre-chamber receives the gaseous hydrogen and the gaseous oxygen from the reservoir.

3. The pre-chamber combustion system of claim 2, further comprising:
a check valve disposed between the electrolyzer and the gas reservoir, the check valve configured to regulate a flow of the gaseous oxygen from the electrolyzer to the gas reservoir.

4. The pre-chamber combustion system of claim 1, further comprising:
a gas injector connected to the pre-chamber, wherein the gas injector is actuated to inject the gaseous hydrogen and gaseous oxygen into the pre-chamber.

5. The pre-chamber combustion system of claim 1, further comprising:
a tank configured to hold liquid water; and
a pump configured to pump water from the tank to the electrolyzer.

6. The pre-chamber combustion system of claim 1, further comprising a plurality of pre-chambers connected to respective main chambers of a gas engine, wherein each of the pre-chambers receive the gaseous hydrogen and the gaseous oxygen output from the electrolyzer.

7. The pre-chamber combustion system of claim 1, further comprising a spark plug at least partially disposed in the pre-chamber.

8. A method, comprising:
electrolyzing water to produce gaseous hydrogen and gaseous oxygen with an electrolyzer;
injecting the gaseous hydrogen and the gaseous oxygen to a pre-chamber fluidly connected to a main chamber of a gas engine through a pre-chamber nozzle; and
igniting the gaseous hydrogen and the gaseous oxygen in the pre-chamber for combustion in the main chamber.

9. The method of claim 8, further comprising:
storing the gaseous hydrogen and the gaseous oxygen in a gas reservoir.

10. The method of claim 8, further comprising:
regulating the flow of the gaseous oxygen from the electrolyzer to the pre-chamber with a valve.

11. The method of claim 8, further comprising:
receiving, in the pre-chamber, fuel from the main chamber in response to a compression stroke of the gas engine.

12. The method of claim 8, further comprising:
pumping the liquid water to the electrolyzer from a tank.

13. An internal-combustion machine, comprising:
an engine having an engine cylinder which partially defines a main chamber;
a pre-chamber fluidly connected to the main chamber through several pre-chamber nozzles;
an electrolyzer configured to receive liquid water and output gaseous oxygen and gaseous hydrogen,
wherein the gaseous oxygen and the gaseous hydrogen output from the electrolyzer are ignited in the pre-chamber to produce hot combustion gases that enter the main chamber.

14. The internal-combustion machine of claim 13, further comprising
a gas reservoir configured to store the gaseous hydrogen and the gaseous oxygen output from the electrolyzer, wherein the pre-chamber receives the gaseous hydrogen and gaseous oxygen from the reservoir.

15. The internal-combustion machine of claim 14, further comprising:
a valve which regulates flow of gaseous oxygen from the electrolyzer to the gas reservoir.

16. The internal-combustion machine of claim 13, further comprising:
a gas injector connected to the pre-chamber, wherein the gas injector is actuated to inject the gaseous hydrogen and the gaseous oxygen into the pre-chamber.

17. The internal-combustion machine of claim 13, further comprising:
a tank configured to hold liquid water; and
a pump configured to pump water from the tank to the electrolyzer.

18. The internal-combustion machine of claim 13, further comprising a plurality of pre-chambers connected to respective main chambers, wherein each of the pre-chambers receive the gaseous hydrogen and the oxygen output from the electrolyzer.

19. The internal-combustion machine of claim 13, further comprising a spark plug at least partially disposed in the pre-chamber.
